(19) United States
(12) Patent Application Publication
(10) Pub. No.: US 2007/0174230 A1
(43) Pub. Date: Jul. 26, 2007

(54) System and method for displaying information in association with an electronic file management application

(76) Inventor: Eric Richard Martin, Atlanta, GA (US)

Correspondence Address: KING & SPALDING LLP, 1180 PEACHTREE STREET, ATLANTA, GA, 30309-3521, US

(21) Appl. No.: 11/655,681

(22) Filed: Jan. 19, 2007

Related U.S. Application Data
(60) Provisional application No. 60/762,190, filed on Jan. 25, 2006.

(51) Int. Cl. G06F 17/00; G06F 17/30; G06F 3/048; G06F 7/00

(52) U.S. Cl. 707/1; 715/862; 715/501.1; 715/711

(57) ABSTRACT

Displaying associated information adjacent to, or in proximity of, an electronic file displayed within an electronic file management application. An e-file callout system associates e-file callout information with an electronic file. When a user hovers or selects an electronic file, an e-file callout is displayed that may include advertising or other information. The e-file callout may be displayed a pre-programmed number of times to the user.

### RELATED PRIORITY APPLICATION

The present application claims priority to U.S. Provisional Patent Application No. 60/762,190, filed on Jan. 25, 2006, which is hereby fully incorporated herein by reference.

### FIELD OF THE INVENTION

The present invention relates to the fetching and displaying of images and text, as well as the transmission of audio, to targeted groups of users over a computer network. More particularly described, the present invention relates to a system and method for displaying images and text (and transmitting audio in accordance therewith) when a user hovers or selects an electronic file displayed in an electronic file management application.

### BACKGROUND OF THE INVENTION

The global interconnection of computers and computer networks is commonly referred to as the Internet. The Internet is a collection of smaller wide area and local area computer networks connected together, thereby allowing the sharing of resources and facilitating data communication between computers and users. Graphical User Interfaces (“GUIs”), including browsers and certain electronic file management applications, allow users to easily access network servers and computers connected to the Internet and, in particular, allows easy access to a subset of the Internet known as the World Wide Web (hereinafter referred to as the “web”).

The web includes a collection of servers, computers, and other devices. Each server connected to the web may contain documents formatted as Web pages (i.e., web sites) or hypertext documents that are accessible and viewable with a browser utilizing hypertext transfer protocol (HTTP), including, but not limited to, Internet Explorer, FireFox®, Safari™, Netscape Navigator®, and MOSAIC™. Hypertext documents often contain hypertext links to other hypertext documents that can be accessed from the first hypertext document by activating the hypertext links. As is understood by one of ordinary skill in the art, the term “link” refers to a selectable reference that directs a user to additional information, including but not limited to, an electronic document or a webpage. Links are sometimes referred to as “hot links” or “hyperlinks” that, when selected by a user, access a referenced hypertext document or other electronic document.

Hypertext documents, files, or web pages generally contain text, graphics, images, sound, and/or video and are generally written in a standard page or hypertext document description language known as Hypertext Markup Language (HTML). Using an HTML format, a web developer can specify the location and presentation of text, graphics, images, sound and video on the screen displayed to a user accessing the web page. HTML format also allows a Web page to contain links, such as the hypertext links described above, to other web pages or servers on the Internet. By selecting a link, a user can be transferred to the new web page or open a new browser window and Web page which may be at a different geographical or topological location from the original Web page.

As is known by one of ordinary skill in the art, flash animation may be used to display images or video to a user when the user activates a hypertext link by, for example, moving an indicator over the top of the link. Flash animation can be created by a software program and may contain text, graphics, images, sound, and video.

Personal computers, personal digital assistants, cell phones, digital music players, digital video recorders (e.g., TiVo® and DVRs), and digital video players (DVD), among other electronic devices, generally include a system unit, an associated video display terminal, a keyboard, and a mouse controlling a cursor or some other hand guided tool controlling a highlighter function. The mouse is commonly used as a relative pointing device indicator. By moving the mouse across a flat surface, the user can control movement of a mouse pointer, as seen on the video display terminal. By moving any other hand guided tool controlling a highlighter function, the user can control movement of the highlighter, as seen on the video display terminal.

A mouse or other pointer device is displayed as a cursor or indicator, e.g., a small arrow or other symbol, on the video display terminal that moves as the user moves the mouse or other pointing device. The area of the screen where the mouse pointer appears can serve as a target for action. To select items or to choose commands displayed on a video display terminal, the user typically manipulates the mouse or other device to place the pointer or the cursor proximate to the desired target and presses one or more buttons or other actuators on the hand-guided tool (e.g., clicking the mouse). One skilled in the art will recognize the difference between clicking, dragging, and hovering using a mouse button. For instance, the term “click” refers to the act of pressing a mouse button down and then immediately releasing it; the term “drag” refers to pressing and holding the mouse button down while moving the mouse and not releasing the button; and the term “hover” refers to moving the mouse pointer over a target initiating an action without a click or drag. The phrase “to click on” means to select an object displayed on the video display terminal by moving the mouse pointer to the position of the object or the highlighter over a file, and clicking a mouse button or highlighter device button.

An application program (or, simply, an application) is software that is not part of a computer's underlying operating system that performs a collection of related functions on behalf, and under the control, of a user. Application programs allow a user to create and manage different kinds of information. Generally, an application can be characterized by (a) a graphical user interface (GUI), that is, the way in which users interact with the application, (b) a data storage scheme, that is, the way in which the application stores its data, and (c) the internal manipulations and transformations that the application applies to the data. In general, applications that fall in the same category have similar behavior but differ in their user interfaces, their data storage schemes, and their internal transformations.

Examples of applications include, but are not limited to, spreadsheets, word processors, drawing packages, presentation graphics, email, photo albums, music players, video players, and book viewers, all of which include some form of an electronic file management system. Commercial applications that include an electronic file management system include, but are not limited to, Microsoft Windows Explorer, Devonthink Professional®, Tinderbox®, TheBrain®, MindManager®, Microsoft Windows Media Player®, iTunes®, Real Player®, TiVo®, satellite and cable TV DVR systems, peer-to-peer network and channel file sharing systems such as Naptster®, BearNet™, Gnutella™, Freenet™, online applications such as Microsoft Online Office®, and email programs either accessed locally such as Microsoft Outlook® or accessed via a web application and/or Internet browser such as Gmail™, Hotmail™, Yahoo®, etc. to name several. These applications are connected to the Web and access computers and servers in a similar manner to HTML pages within a browser.

In today's competitive market, advertisers are finding it more and more difficult to target and effectively sell products to online consumers. Conventional systems do not guarantee that potential customers will see advertisements and oftentimes there is no way to develop an advertising strategy for certain consumers until large amounts of data are tracked for that user through the often-used device of “cookies.” Conventional online advertisements are typically done through one of the following ways: rich media; leader board; skyscraper; expandable ads; overlay; interstitial; pop-up; home page takeover; on-page video; and in-stream video. Rich media is a collection of technologies behind Web page special effects, such as animation, video and interactive games. Rich media requires an extraordinary amount of processing capability and is often by-passed by online users. Leader board is a larger version of the traditional rectangular banner ads that typically stretch across the top of Web pages. These types of banners are one of the oldest and most accepted forms of Internet advertising, but do not guarantee that a potential customer will see the advertisements, as they are away from the primary activities that the user may be engaged in. Skyscraper advertisements are tall ads that run on the sides of Web pages. Like leader boards, there is no guarantee that a user will pay attention to these advertisements. Expandable ads are advertisements that are displayed as banners or skyscrapers, but grow larger when a Web surfer moves over them or clicks with a mouse. These advertisements face the same disadvantages as banners and skyscraper advertisements face. Overlay advertisements, also called writeover or floating ads, are promotions that hover over a Web page within a browser window. Overlay ads often deliver animation or video and may be static displays of varying sizes, or may have animated creatures or vehicles moving across a page. One disadvantage associated with these types of advertisements is that they may give users the option to bypass them. Interstitial advertisements are typically displayed in between Web pages when a user is linking from one to another. These advertisements may also be skipped by a user. Pop-up advertisements open in a new browser window on their own at the front of a screen. With the advent of pop-up blocking programs, many advertisers have curtailed their use of these types of advertisements.

Home page takeover is a broad term that includes overlay and other advertisements that entirely cover a Web page or manipulate its contents. Home page takeovers are disadvantageous because they remove content and can often quickly by-passed by a user. On-page video is video contained inside a Web page advertisement, including static displays and those that expand. The video may start by itself or may require a user to turn it on. Video advertisements require a lot of bandwidth and processing capability and may be immediately by-passed by a user. Finally, in-stream video advertisements resemble TV commercials and are embedded into online video content before or during programs such as news, sports or music videos. In-stream video advertisements are often only available when a user is connected to the Internet.

Thus, while conventional advertisement programs are able to display content to users, they are often not able to do so in an off-line environment (i.e., when not connected to the Internet), do not guarantee that a user will see the advertisement, often require the collection of data before targeted advertisements may be generated and, in some cases, can be completely by-passed or cancelled by a user. Accordingly, there exists a need in the art for an improved system that can provide advertisers with a more targeted and efficient way to deliver information and content to potential customers, regardless of what type of electronic device is being utilized and regardless of whether a customer is connected to a network.

### SUMMARY OF INVENTION

The e-file callout system can display targeted information in association with an electronic file management application. The e-file callout may comprise a software program that is capable of associating information with an electronic file that is managed by an electronic file management application and displaying that information when a pointing device indicator (cursor on pointer) is placed in close proximity to an identifier of the electronic file (e.g., the electronic file is hovered over or selected). The information that is displayed may reside (i.e., stored or otherwise maintained) in a storage device that is local or remote to the electronic file management application. The information that is displayed may comprise graphics, video or audio. The information may also comprise at least one link (e.g., hypertext link, hyperlink, graphical link, etc.). When this link is selected, additional information may be displayed. This additional information may reside on a storage device that is local or remote to the electronic file management application.

The e-file callout system may display the information a pre-programmed number of times. The information may be changed periodically, or after it has been displayed a predetermined number of times. The information that is associated with the electronic file may be selected based on an attribute of the electronic file. Similarly, the information that is associated with the electronic file may be selected based on an attribute of a user of the electronic file or through the use of third-party segmentation data.

The e-file callout system may be utilized in a wide array of applications. For example, the e-file callout system may be utilized to display advertising information. Advertising space may be provided to an advertiser, wherein the advertiser may select an advertisement to display utilizing the e-file system. For a representative business model, an electronic file can be provided to a user of an electronic file management application at a price that is less than normal retail. The electronic file and electronic file management application may be provided by different parties. When a pointing device indicator is placed in close proximity to the electronic file identifier, the advertisement associated with the file is displayed in a graphical user interface. Accordingly, the e-file system is capable of incenting advertisers to purchase advertising space and users (i.e., consumers) to view the advertisements.

### BRIEF DESCRIPTION OF THE DRAWINGS

The advantages and aspects of the present invention will be more fully understood in conjunction with the detailed description which follows, and the accompanying figures, wherein:

FIG. 1 illustrates a representative operating environment for the e-file callout system, according to an exemplary embodiment.

FIG. 2 illustrates a method for utilizing the e-file callout application, according to an exemplary embodiment.

FIG. 3 illustrates a high level process overview required to display or keep suppressed an e-file callout generated by the e-file callout system, according to an exemplary embodiment.

FIGS. 4 and 5 illustrate a method for activating the e-file callout system, according to an exemplary embodiment.

FIG. 6 illustrates a method for utilizing the e-file callout tool, according to an exemplary embodiment.

FIG. 7 illustrates a method for utilizing the e-file callout system, according to an exemplary embodiment.

### DETAILED DESCRIPTION OF THE EXEMPLARY EMBODIMENTS

The inventive e-file callout system facilitates the segmenting of prospective online consumers to develop targeted online advertising campaigns by associating advertisement based upon attributes of electronic files, displaying advertisement information to potential consumers via callouts associated with the electronic files, and providing links for users to open Internet browsers to effect online sales based on the targeted advertisements associated with the electronic files. The e-file callout system may be utilized, among other electronic devices, in personal computers, personal digital assistants, cell phones, digital music players, digital video recorders (e.g., TiVo® and DVRs), or digital video players (DVD).

The e-file callout system provides a unique alternative to conventional types of electronic advertising. For example, unlike conventional advertising schemes, the e-file callout system may allow an advertiser to advertise in an online or offline state, directly target potential customers based on attributes of electronic files downloaded by potential customers, and ensure that customers will see the advertisements when the downloaded electronic files are accessed. In addition to these advantages, further advantages of the e-file callout will be apparent to one of ordinary skill in the art in view of the drawings and detailed description provided hereinafter.

The e-file call-out system may comprise a software program (i.e., application) and a network-based tool. The software program is designed to show information in the form of graphical text or video in a callout window (herein referred to as an “e-file callout”) when a user hovers or highlights an electronic file. The e-file callout may comprise a flash image or similar type of software generated window (e.g., java, html, etc.) appropriate for displaying information such as graphical text or video. The software program may be part of an electronic file management application or may be downloaded by a user as a plug-in for an electronic file management application. Alternatively, a user may have downloaded an electronic file management system and the e-file software program may be a portion (e.g., part of) the electronic file management system or the e-file software program may reside in a different application. If the e-file software program is part of the electronic file management application (e.g., iTunes®), it can be written in any software that the electronic file management application is written in. One of ordinary skill in the art knows how to construct a software program capable of providing the functionality required by the e-file callout system.

The e-file callout system may be programmed to display a distinct number of incidents from 1 to infinity. The callout may comprise graphics, text or audio. The system works not only when connected to the Internet, but may also function through locally stored files (i.e., information may be downloaded to a local terminal and displayed while not connected to the Internet). Information may be updated periodically and automatically while connected to the Internet. Information may be determined through built-in performance systems and standard connectivity to third party market segmentation systems.

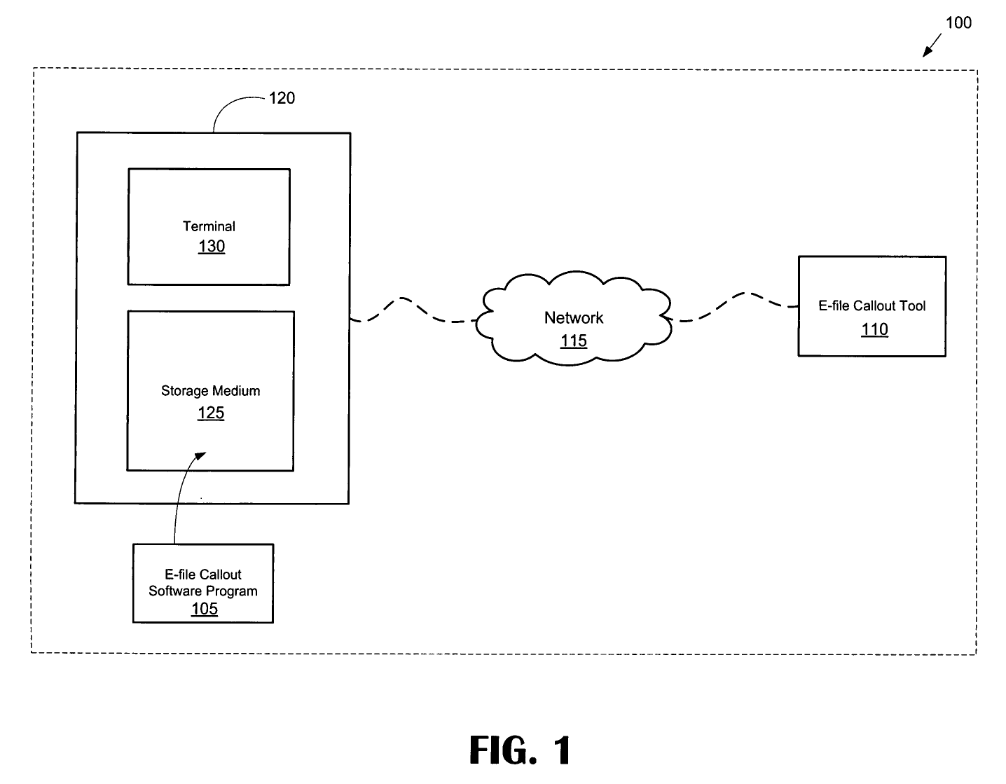

FIG. 1 illustrates a representative operating environment 100 for the e-file callout system. As illustrated, the representative operating environment 100 for the e-file system comprises an e-file callout application 105, a network 115, and an e-file callout tool 110. The e-file callout application 105 may reside on an electronic device 120 such as, but not limited to, a personal computer, personal digital assistant, cell phone (e.g., iPhone®), digital music player, digital video recorder (e.g., TiVo® and DVRs), or digital video player (DVD). The electronic device 120 may comprise a terminal 130 and a storage medium 125. The terminal 130 may be any device capable of displaying a graphical user interface (GUI). A storage medium 125 may be any number of devices capable of storing electronic files including, but not limited to, a local hard drive (i.e., a database directly attached to a terminal), a separate hard drive (i.e., a hard drive separated from a terminal, but in the same location), or a remote database (e.g., web server or database server attached via an Internet connection). As illustrated, the terminal 130 and storage medium 125 may reside in one unit (e.g., one electronic device). For example, the terminal and storage medium may be combined in one unit in devices such as, but not limited to, portable digital video players, electronic music devices (e.g., iPod®), or mobile phones (e.g., iPhone®).

The network 115 may comprise any communication medium capable of exchanging electronic data. Furthermore, while the e-file callout software program may be downloaded and installed on a device via the network 115, the e-file callout system can function regardless of the status of the network connection. Accordingly, it is not required that the electronic device 120 be connected to the network 115 in order for the e-file system to operate.

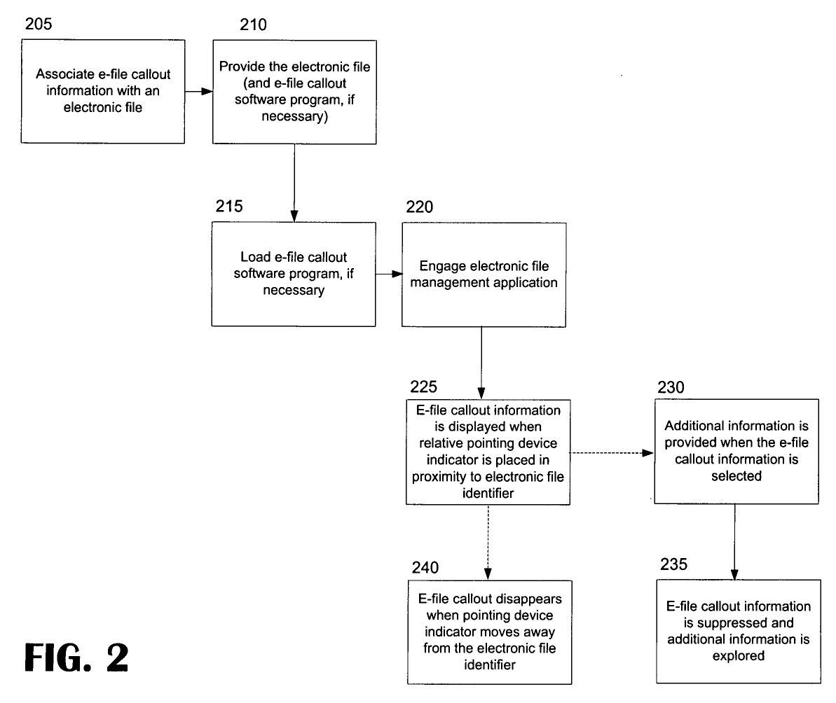

FIG. 2 illustrates an exemplary method for utilizing the e-file callout system. At step 205, e-file callout information is associated with an electronic file that can be managed by an electronic file management application. The e-file callout information may be associated with the electronic file based on any number of factors including, but not limited to, the type of electronic file, metadata associated with the electronic file, or the user seeking to download the electronic file. At step 210, the e-file callout information (and potentially, the e-file callout system software program) are downloaded to an electronic device. At step 215, if necessary, the e-file callout software program is loaded onto the operating system of the electronic device 120. At step 220, the electronic file management application is started by the user. At step 225, the e-file system displays the information (i.e., callout) to the user when the user places the pointing device indicator over the identifier for electronic file (e.g., hovers or selects the electronic file name or symbol) in the electronic file management application.

Steps 220 and 225 are performed in a software program functionally connected to the electronic file (either as a part of it or separate application). A module of the software application may trace when a user is moving a cursor around on a screen. When the cursor stops moving (i.e., hovers) over an electronic file, the software recognizes the inactivity, recognizes the hovered electronic file, and displays the e-file callout to the user in a window that may be immediately adjacent, or in close proximity, to the electronic file. At step 230, the user clicks the e-file callout to display additional information regarding the e-file callout. The user may then choose to utilize the browser, which in turn suppresses the e-file callout at step 235. Alternatively, at step 240, the user may not wish to select the e-file callout and may instead move away from, or de-select, the electronic file, thus suppressing the e-file callout.

Thus, according to the exemplary embodiment illustrated in FIG. 2, in a conventional file management system—either built for the sole purpose of managing files—or built within an application designed primarily for another purpose (referred to either way as a electronic file management application for the purpose of the e-file callout system), if a user clicks on an e-file callout, a browser opens to a new window displayed within the user's terminal. Each window may comprise, for example, web pages, links to other web pages, or hypertext documents. Activating a link available on an e-file callout in this manner provides the user with an ability to navigate or move to and display or download different documents, pages, sites, or other information via the computer network. Thus, when the user places the graphical representation of a cursor over a desired e-file callout, and clicks one of the mouse buttons at the e-file callout, the user can go to an alternate site.

As set forth in this embodiment, to activate any e-file callout that is displayed as a result of hovering or highlighting a file in an electronic file management application, users must click on the e-file callout to open a new window, such as an Internet browser, to arrive at a website. Accordingly, the e-file callout system provides a system and method by which a user no longer needs to be in a browser to encounter certain types of communications such as, but not limited to, advertising. The e-file callout system thereby provides a method in which a user does not need to click to encounter advertising. This is highly advantageous in today's ultra-competitive advertising market.

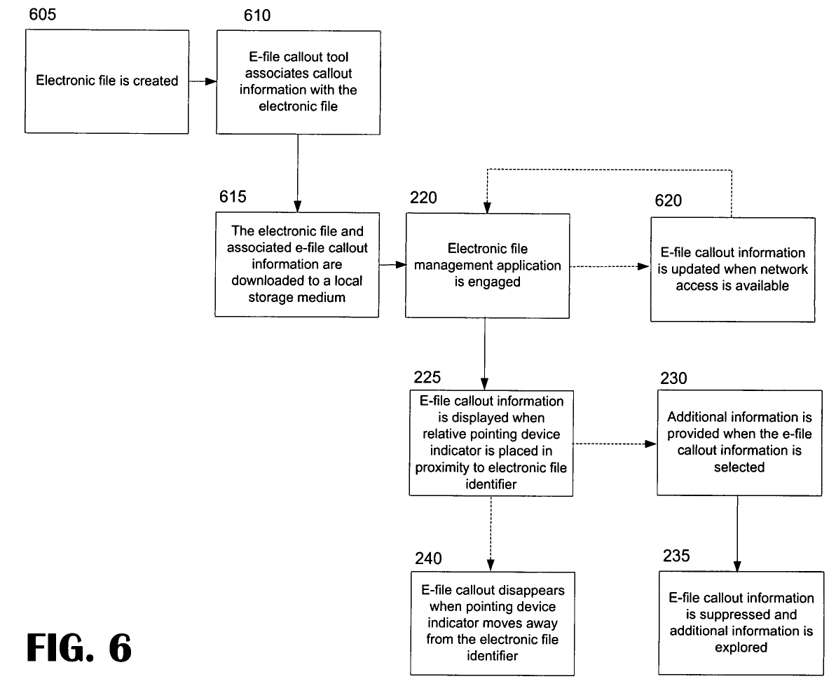

Another advantage of the inventive e-file callout system is that the system may appear seamless to a user. For example, a user may download a popular electronic file management system application (e.g., iTunes®) and open the application to manage electronic music files. Using a mouse and pointer, the user hovers over a specific electronic file name displayed within the user interface of the application. Appearing visually adjacent to, or in close proximity to the file, an e-file callout appears which may include advertising graphics and text in an exemplary embodiment. The user may subsequently click on the e-file callout, which according to this exemplary embodiment, automatically opens an Internet browser set to display a specified web page as indicated by the advertising e-file callout. In this way, the user is presented with advertisement that may be directly related to the downloaded music file. For example, the e-file callout may contain upcoming concert information for the artist of the music contained in the electronic file. Further, as will be described in relation to FIG. 6, below, this advertising information may be updated if the e-file callout application is connected to a network. Thus, in the advertising embodiment, the e-file callout for a particular music file may be changed to target band merchandise once a concert date has passed. Similarly, the e-file callout may also contain advertising information based upon information related to the user. For example, an e-file callout may be associated with an electronic file based on the user of the electronic file and may therefore display an advertisement for Energie®, a popular Italian clothing designer. In this example, when the user clicks the e-file callout, an Internet browser may open to a targeted Energie® web page.

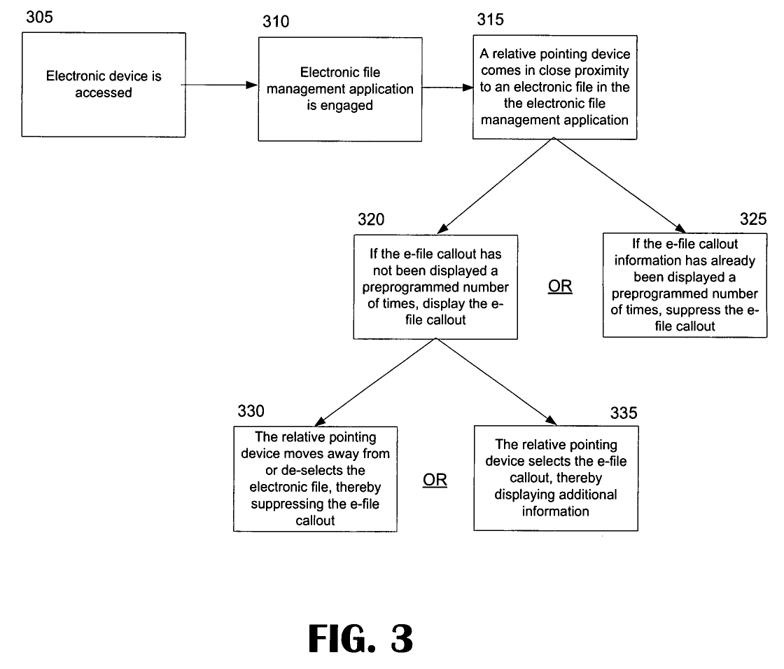

A user no longer needs to be connected to the world wide web to encounter advertising for an exemplary embodiment of the present invention. For example, the e-file callout information may reside on local media storage or remote storage media. The e-file callout system additionally provides advertisers with an opportunity to work directly with software makers to facilitate direct advertising through electronic file management applications without utilizing real estate within the software maker's electronic file management applications. As known to one of ordinary skill in the art, “real estate” is the space provided on a web page or within a display window in applications dedicated for a particular purpose or function. The e-file callout system provides software makers with additional functionality to existing applications that present opportunities to collect from and share revenues with advertisers. The e-file callout system further provides a method to present advertising a specified number of incidents per advertisement (as is described in more detail in relation to FIG. 3, below).

FIG. 3 illustrates the high level process overview required to display or keep suppressed an e-file callout. At step 305, a user accesses an electronic device 120, such as a personal computer. At step 310, the user accesses an electronic file management application (“EFMA”) comprising or functionally connected to the e-file callout application. The e-file callout application may either be an original or add-on feature of the EFMA. At step 315, the user places a pointer indicator proximate to or highlights a file name or content identifier in the user interface of the EFMA. This triggers the e-file system to transmit a signal to a database. If the electronic device being used by a user is connected to a network, then the database may be remote from the device. According to an exemplary embodiment, if the e-file callout has already been displayed a preprogrammed number of times (i.e., if N is greater than the number of times preprogrammed), then, at step 325, the e-file callout remains suppressed and is not shown to the user. However, if the e-file callout has not been displayed the preprogrammed number of times (i.e., if N is less than or equal to the number of times preprogrammed), then the e-file callout application fetches the e-file callout from a database and displays an e-file callout to the user at step 320. As discussed, this e-file callout may comprise graphics, video, text, audio, or hyperlinks. The user then can click the e-file callout or move the cursor away from the electronic file. At step 330, if the user moves the cursor away from the electronic file (or de-selects the electronic file), the e-file callout disappears. At step 335, if the user selects the e-file callout, a browser opens to information either remote (e.g., Internet web page) or to additional locally stored information. That is, if the device does not have a current connection to the Internet, an expanded e-file callout may be displayed containing additional information stored in local memory and regarding the callout.

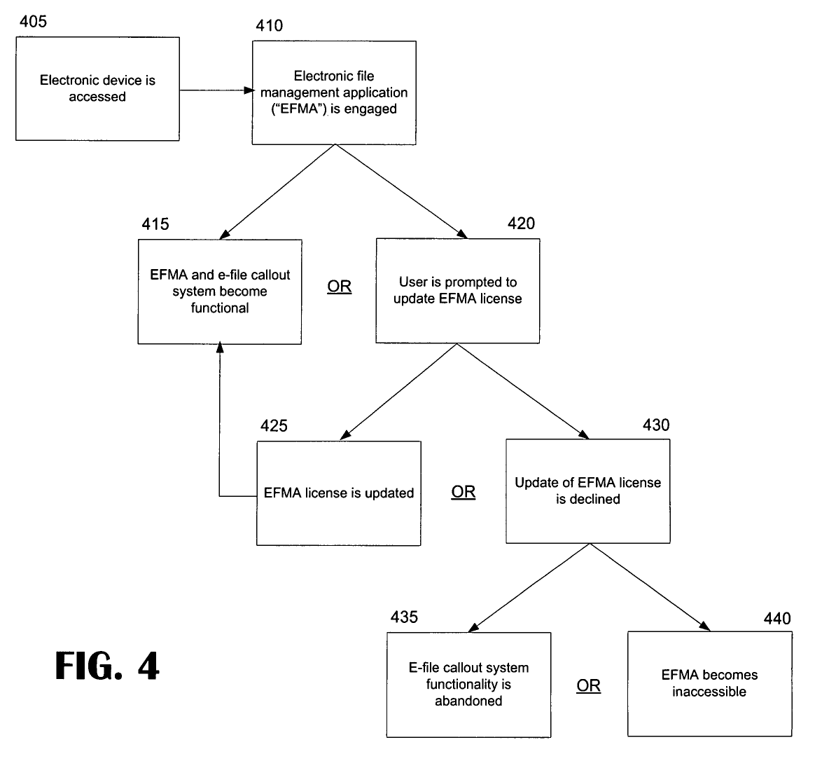

FIG. 4 illustrates how the e-file system utilizes an electronic file management application (“EFMA”). To activate an e-file callout, the EFMA must have a current license to use the electronic file, or the user must request that the license be made current. As is known by one of ordinary skill in the art, if the EFMA does not have a current license, the EFMA will be disabled. If the EFMA is disabled, the e-file callout functionality will also be disabled. This is explained with reference to FIG. 4. At step 405, a user accesses an electronic device to utilize an EFMA. If a user has pre-installed or installs an EFMA with a current license, then the user clicks on or selects the EFMA to access a user interface at step 410. The user is then ready to manage electronic files at step 415.

However, if a pre-installed or user installed EFMA license has expired, at step 420, the user is prompted to update the EFMA license. If the user chooses to update the EFMA license, the user is ready to manage electronic files at step 415. Conversely, at step 430, if the user declines to update the EFMA license, either the e-file callout system functionality becomes abandoned at 435 and the EFMA opens or, alternatively, at step 440, the EFMA itself becomes inaccessible.

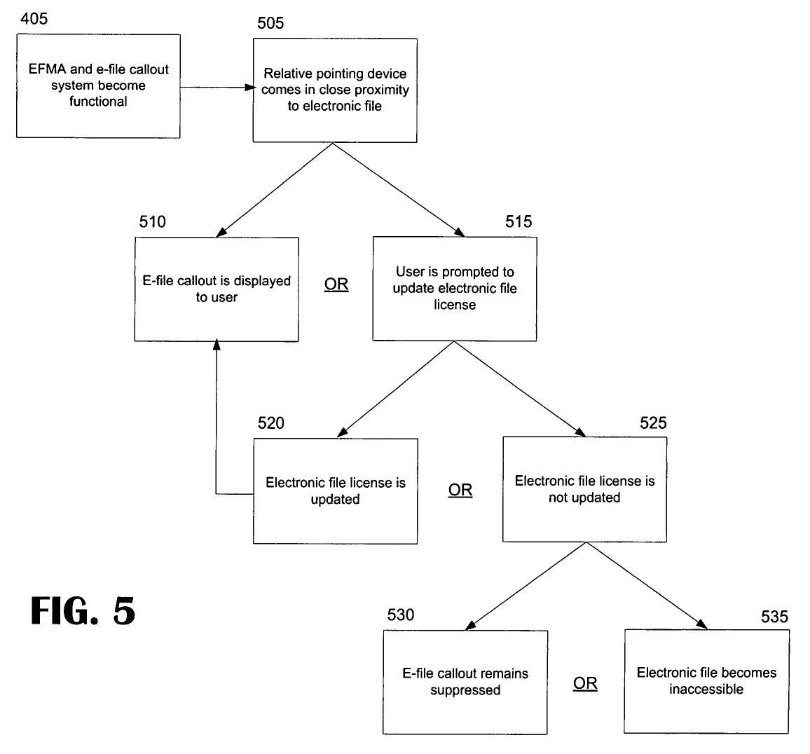

Because the e-file callout system can be embedded within a EFMA, once the EFMA is initialized and the user is ready to manage electronic files at step 415, e-file callout system will also be initialized based upon the license rights of the electronic files being accessed by the user. Hence, if licenses are current and the EFMA is ready to be used, the e-file callout system will function when a user hovers or selects an electronic file (assuming the license for the electronic file is current, as explained with reference to FIG. 5 below).

FIG. 5 illustrates how the e-file system functions with an electronic file once the EFMA is initialized. As explained above, an electronic file must have a current license to activate an e-file callout, or the license must be made current by user, or the file itself will be disabled, or allow for the e-file callout functionality to be disabled while the EFMA and electronic file remains active. Continuing from step 415, the user is ready to manage electronic files. If a user has a pre-saved file on storage media with current license, or downloads a file to storage media with a current license, then the e-file callout will be ready to operate when a user hovers or selects the electronic file at step 505, thereby displaying the e-file callout to the user at step 510. However, if the pre-saved or downloaded file license is expired or unauthorized, the user is prompted, at step 515, to update the license. If the user updates the license, then the e-file system functionality is initialized at step 520 and the electronic file is ready to be used. Alternatively, if the user declines to update the license at step 525, either the e-file system functionality is abandoned and the e-file callout remains suppressed at step 530 or the electronic file becomes inaccessible at step 325. Pursuant to this exemplary embodiment, a third-party providing users with electronic files associated with e-file callouts can require that the user see the e-file callouts in order to utilize the electronic files. This feature would prevent a user from bypassing or skipping the e-callout information—such as advertising information—that may be included in the e-file callout.

FIG. 6 illustrates how a third-party may develop and associate an e-file callout with an electronic file utilized by an EFMA, according to an exemplary embodiment. This exemplary embodiment may be utilized when a third-party develops a file intended to be provided to a licensed end user within an EFMA that includes the e-file callout functionality. In this embodiment, the third-party must setup the e-file callout associations using the e-file callout tool. The third-party accesses the e-file tool that includes its own GUI and database that tracks the pertinent information that maintains all associations between the file and the EFMA. Certain source information, such as license expiration dates, may reside on the end user's locally installed EFMA, while certain other source information may reside within the remote e-file callout tool. Such information may include a file identification number from which all system and file rules are based for a single file. An EFMA with active e-file callout system functionality automatically runs the program to check for any, and determine which, actions to take when the EFMA is open and a user is hovering or highlighting files within the EFMA.

According to this exemplary embodiment, a third-party (e.g., a programmer) creates an electronic file at step 605. Next, at step 610, the programmer utilizes the e-file callout tool to associate an e-file callout with the electronic file. The e-file callout may be associated with the electronic file based on an unlimited number of factors, including, but not limited to, the type of electronic file or the genre of copyrightable media stored on the electronic file. For example, in an advertising environment, the e-file callout may be associated with an electronic file comprising music based on the genre of the music stored by the electronic file (e.g., country).

Once an e-file callout has been associated with an electronic file, the electronic file may be downloaded by a user to a local database at step 615. The e-file callout application then maintains file and e-file callout registry information for the electronic file, including data associations, licensing, expiration, content, performance, etc. The e-file callout application further regularly checks the system registry to determine actions. Accordingly, as previously described with relation to FIG. 2, if the EFMA is engaged by a user, then an e-file callout may be shown to a user as illustrated in steps 220-240.

Further, according to the exemplary embodiment illustrated in step 620 of FIG. 6, if the e-file callout application becomes connected to a network 115, the e-file callout information associated with a certain electronic file may be updated. That is, in certain instances, it may be advantageous to download new e-file callout information to display to a user. The e-file callout application therefore may query the e-file callout tool for updated e-file callout information when it is connected to the network 115.

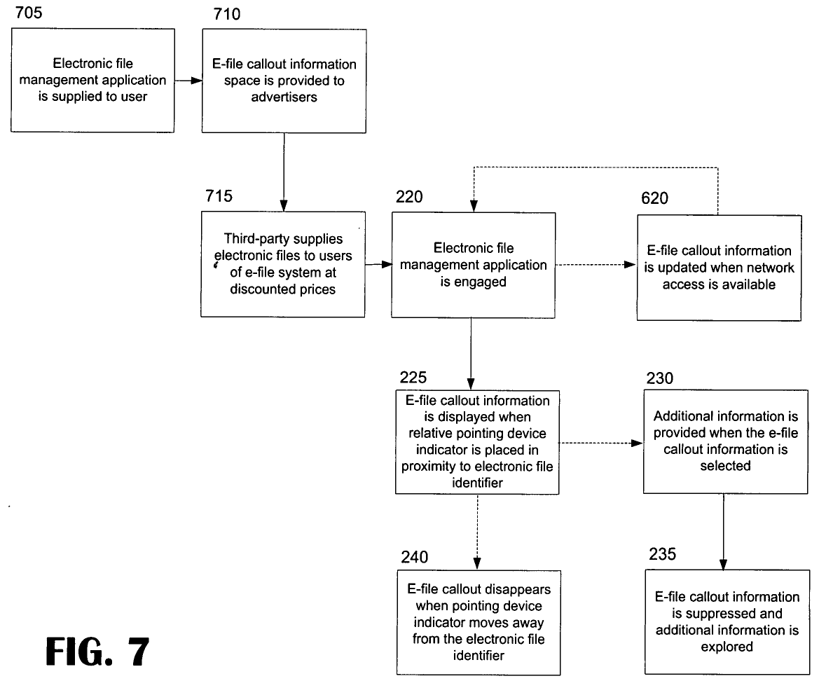

An exemplary business use for the e-file callout system is illustrated in FIG. 7. As previously described, at step 705, a third-party supplies an electronic file management application (e.g., iTunes®,) to a user. At step 710, the third-party provides (by selling or otherwise) advertising space to a third-party in the form of e-file callout information. By doing this, at step 715, the third-party is able to supply electronic music or video files to the user at prices less than retail (i.e., discounted). In this embodiment, the electronic files may be supplied to the user at discounted prices because the user agrees to accept e-file callouts with the electronic files. Thus, the e-file callout information is also downloaded by the user when the electronic files are downloaded. According to this exemplary business method, both the consumer and advertisers are benefited by the e-file callout system; the advertisers by getting advertisements in front of willing customers and the users by being able to secure legal electronic media files at discounted prices.

In accordance with the above, additional exemplary commercial use of the e-file callout system could include, but are not limited, to: (1) an online music store employing its own application (i.e., not using a web browser) in order to service customer transactions (e.g., iTunes®) and help customers manage music files; (2) an online music store sells music files at either full retail price or at a discounted price; or (3) an online music store discounts prices for customers willing to accept the version of the music store's application that allows e-file callouts.

In commercial uses where an online music store sells music, upon each purchase from the online music store, the buyer using an EFMA incorporating the e-file callout system will have downloaded to its local hard drive the associated e-file callout advertising information with each purchased music file, in addition to any connectivity instructions to additional advertising information stored on a remote storage media to be accessed when customer is online. Such advertising information provided to customers with each downloaded electronic file may be selected by advertisers through decision making tools comparing data from system and third-party market segmentation data (e.g., PRIZM, P$YCLE and ConneXions). The amount of data that is available for displaying advertisements with the e-file callout system may be based on the segmentation software that is connected to the system. For example, if the segmentation data is built into an electronic file management application, such as iTunes®, then demographics would be readily available for determining which advertisements to place with certain e-file callouts. Likewise, if the segmentation software is a stand-alone program, then this segmentation software may be connected to the e-file system in such a way to allow advertisers information to associate advertising information with the e-file callouts.

Further, as described previously, according to an exemplary embodiment, the e-file callout system may be programmed to display a certain number of incidents before the e-file callout is terminated for any specific music file purchased by customer. Hence, an electronic music file purchased from an online music store at a discounted price may include information signifying to the e-file system that the e-file callout is only to be displayed 15 times to a user. According to this example, once the e-file callout is displayed 15 times, the callout will not be displayed to the user when the user hovers or selects the electronic music file. Thus, one significant advantage of the e-file callout system is that it allows online music stores and advertisers to contract terms based upon advertising agreements. This would allow online music store to offer discounts, while incenting advertisers to buy advertising space and share revenue.

In view of the foregoing, it will be understood that the e-file callout system may comprise an application and network-based tool. The e-file callout tool is capable of residing on a remote Web server or separate data base server and executes the advertising campaign business rules, content and media. The e-file callout application may comprise a software program running on an operating system. The system may be programmed to display a distinct number of incidents (i.e., callouts) from one to infinity. The incidents may comprise graphics, text, and audio. The system is capable of operating regardless of whether or not it is connected to a network. For example, when disconnected from a network, the e-file callout system may utilize local files and may update files when or if a network connection becomes available.

The e-file callout system can utilize media files located on a local or remote database or discrete web server to display incidents to a user. The locally stored media files may be created by an external system and may include, but are not limited to, music, videos, and books. Media selected by media providers may be determined through built-in performance system and standard connectivity to third-party market segmentation systems. The e-file callout system may communicate with a software application via a “plug-in” or it may be an original part of the application functionality. The e-file callout system may be used with any number of applications utilizing an electronic file management system, including, but not limited to, iTunes®, Yahoo! Music®, Napster®, etc.

When installed by a user (either as part of an application or via plug-in), the e-file callout system may display a floating window, otherwise referred to as an “e-file callout,” when the user places a cursor or selects an identifier for an electronic file maintained by an electronic file management system. The e-file callout may comprise targeted information selected based on certain attributes of the electronic file or the user of the electronic file.

In an exemplary embodiment, the user may select the e-file callout or move the cursor away from the electronic file to make the e-file callout disappear. In this embodiment, the e-file callout may comprise links so that the user may be directed to another window, such as a browser, upon clicking on the callout. For example, upon selecting a link, a browser (e.g., IE Explorer®, Netscape®) may open to display additional information related to the information in the e-file callout. The browser may contain, for example, a website, links to other websites, or hypertext documents. Thus, activating a link available on the e-file callout may provide the user an ability to navigate, move, display, or download different documents, pages, sites, or other information via the computer network. Further, because of the attributes of the electronic file to which the e-file callout is programmed to display, the user may be directed to sites with interests related to that person. For example, in a music application (e.g., iTunes®), advertising may be keyed to the attributes of a specific music file (e.g., artist, genre, etc.) and the e-file callout may include information specifically based on those attributes.

Based on preferences stored in the e-file callout system, the callout may be displayed to the user any number of times from one to infinity. The callout may also be displayed to the user regardless of whether the device is connected to a network such as the Internet. However, in an exemplary embodiment, the e-file callout system may update advertisement associated with the electronic files stored in the application when a connection is available to a network.

Although the invention has been shown and described in a preferred form with a certain degree of particularity, it is to be understood by those skilled in the art that the present disclosure has been made only by way of example, and that numerous modifications to the method may be made without departing from the spirit and scope of the invention as hereinafter claimed. Thus, while the e-file callout system may be particularly adaptable for use by the Internet Advertising community, there are many other applicable uses of the e-file callout including, but not limited to, communicating periodic updates, communicating file licensing status, and providing content within a corporate file management system.

I claim the following:

1. A system for displaying information in association with an electronic file management application, comprising:
a software program functionally connected to the electronic file management application, the software program operative to perform the following tasks:
associate the information with an electronic file that is managed by the electronic file management application;
display the information when a pointing device indicator is placed at or in proximity to an identifier for the electronic file.

2. The system recited in claim 1, wherein the information resides on a storage medium that is local to the electronic file management application.

3. The system recited in claim 1, wherein the information resides on a storage medium that is remote from the electronic file management application.

4. The system recited in claim 1, wherein the information comprises a hyperlink.

5. The system recited in claim 4, wherein the software program performs the tasks of displaying additional information when the hyperlink is selected.

6. The system recited in claim 1, wherein the software program displays the information a pre-programmed number of times.

7. The system recited in claim 1, wherein the software program is implemented as a portion of the electronic file management application.

8. The system recited in claim 1, wherein the software program is associated with the electronic file management application in response to an update to the electronic file management application.

9. The system recited in claim 1, wherein the information is updated when the software program is connected to a network.

10. A method for displaying information in association with an electronic file management application, comprising the steps of:
associating the information with an electronic file that is managed by the electronic file management application;
displaying the information when a pointing device indicator is placed at or in proximity to an identifier for the electronic file.

11. The method recited in claim 10 further comprising the step of downloading the electronic file and information over a network for use in association with the electronic file management application.

12. The method recited in claim 10, wherein the information that is displayed comprises content that is targeted based on characteristics of the electronic file.

13. The method recited in claim 10, wherein the information that is displayed comprises content that is targeted based on the characteristics of a user of the electronic file.

14. The method recited in claim 10, wherein the step of displaying information is accomplished through the use of a software program functionally connected to the electronic file management application.

15. The method recited in claim 10, further comprising the step of updating the information when a network connection is available.

16. A method for displaying information in association with an electronic file management application, comprising the steps of:
installing the electronic file management application via a computer network, the electronic file management application comprising a software program operable to display primary information in a graphical user interface when a pointing device indicator is placed in close proximate to an identifier of the electronic file; and
wherein the primary information is located on a storage medium that is local to the electronic file management application.

17. The method recited in claim 16, further comprising the step of displaying the primary information a pre-programmed number of times.

18. The method recited in claim 16, wherein the primary information comprises a hyperlink.

19. The method recited in claim 18, wherein the software program displays secondary information in response to selecting the hyperlink.

20. The method recited in claim 18, wherein the secondary information is related to the primary information

21. The method recited in claim 19, wherein the secondary information resides on a storage medium that is local to the electronic file management application.

22. The method recited in claim 19, wherein the secondary information resides on a storage medium that is remote to the electronic file management application.

23. The method recited in claim 19, wherein the software program displays the secondary information via a browser.

24. The method recited in claim 16, wherein the information comprises content that is targeted based on the characteristics of the electronic file.

25. The method recited in claim 16, wherein the information that is displayed comprises content that is targeted based on the characteristics of a user of the electronic file.

26. A method for displaying targeted advertising information in association with an electronic file management application, comprising the steps of:
providing advertising space for the display of information as an advertisement;
selling an electronic file to be managed by the electronic file management application at a price that is less than retail price for content of the electronic file;
displaying the advertisement when a pointing device indicator is placed proximate to an indicator for the electronic file.

27. The method recited in claim 26, wherein the advertisement is selected based on an attribute of the electronic file.

28. The method recited in claim 26, wherein the advertisement is selected based on an attribute of a prospective user of the electronic file.

29. The method recited in claim 26, wherein the advertisement is selected by utilizing third-party market segmentation data.

30. The method recited in claim 26, further comprising the step of changing the advertisement after the advertisement has been displayed a pre-programmed number of times.

31. The method recited in claim 26, further comprising the step of changing the advertisement on a periodic basis.

32. The method recited in claim 26, further comprising the step of updating information to be displayed in the advertisement when the electronic file management application is connected to a network.

33. The method recited in claim 26, wherein the advertisement comprises a hyperlink that, when selected, displays additional information related to the advertisement.

34. The method recited in claim 26, wherein the advertiser can access a tool to update the information that is displayed as the advertisement.

35. The method recited in claim 26, wherein the electronic file management application and electronic file are provided by different entities.
